(19) United States
(12) Patent Application Publication
(10) Pub. No.: US 2025/0332050 A1
(43) Pub. Date: Oct. 30, 2025

(54) Hospital Bed with a Movable Toilet

(71) Applicant: Jedda Queen, Randallstown, MD (US)

(72) Inventor: Jedda Queen, Randallstown, MD (US)

(21) Appl. No.: 18/649,349

(22) Filed: Apr. 29, 2024

(51) Int. Cl. A61G 9/00

(52) U.S. Cl. CPC A61G 9/003

(57) ABSTRACT

A hospital bed with a movable toilet is an invention made to enhance the traditional hospital bed which is used by patients who are staying in a hospital, assistant living facility, outpatient care clinic or nursing home and are non-weight bearing or bedridden.

### FIELD

A hospital bed with a movable toilet is made for people who are staying in a hospital or nursing home and are non-weight bearing or bedridden.

### BACKGROUND

A hospital bed is a bed specially designed for hospitalized patients or others in need of some form of health care. These beds have special features both for comfort and well-being. In addition, it is an adjustable bed that is typically seen in a hospital setting however it can also be purchased for home use. Although the traditional hospital bed has served patients well, it is missing a very important feature that will help to comfort and protect patients in their times of need.

### SUMMARY

This hospital bed with a movable toilet is one solution to help stop bed sores and save the cost on undergarments bed dressings and diapers.

Protects doctors, nurses and other hospital staff from germs and unwanted diseases.

In addition, protects patient from the humiliating embarrassment that comes with not being able to go to the bathroom on their own and having to lay in their own feces or urine for any length of time or having to lay on a very painful bed pan because of staff shortages.

Moreover, saves on the cost of bed dressings and diapers.

### BRIEF DESCRIPTION OF THE DRAWINGS

FIG. 1 is a view of the hospital bed with the movable toilet. Comprising of, 1 the hospital bed, 2 the movable toilet track, 3 the movable toilet, 4 the uniquely designed mattress with a circular opening, and 6 the pillow.

FIG. 2 is a view of the movable toilet extended out on the movable track to be emptied of its contents.

FIG. 3 is a view of the uniquely designed fitted sheet with circular opening for the hospital beds uniquely designed mattress with circular opening.

### DETAILED DESCRIPTION

As told earlier, a hospital bed is a bed specially designed for hospitalized patients or others in need of some form of healthcare. These beds have special features both for comfort And well-being. In addition, it is an adjustable bed that is typically seen in a hospital setting however it can be bought for home use. Here are some of the features of a traditional hospital bed.

Adjustable height-which allows not only the whole body but also the head and feet sections. Side rails which can be lowered or raised to prevent patients from accidentally falling out of bed.

Electronic comforts-which allows patients or caregivers to adjust the bed's position easily and use other nearby electronic devices.

Alternating pressure mattress-some hospital beds feature alternating pressure mattresses that may use computer-controlled pumps to automatically inflate or deflate, thereby reducing the risk of bed sores.

Bed exit alarm-a pressure pad in or on the mattress that triggers an audible alert. This alarm helps check patients getting in and out of the bed helping to prevent falls or unsupervised wandering with elderly or memory impaired patients.

Used beyond hospitals-hospital beds are not limited to hospitals, but they are also used in nursing homes, assisted living facilities, outpatient clinics and for healthcare at home. https://www.operabeds.com

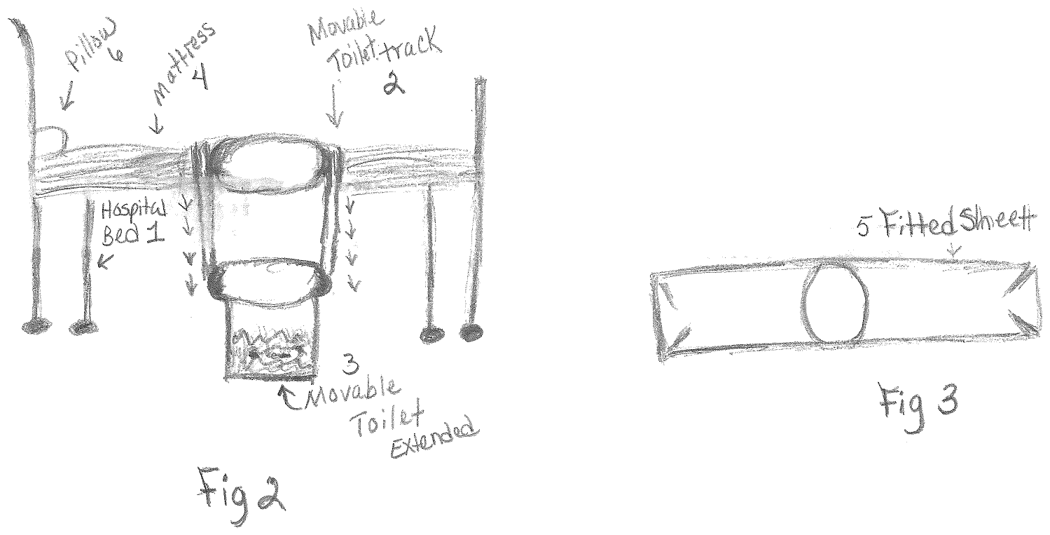

Although the traditional hospital bed has served patients well, it is missing a very important unique feature which is displayed in FIG.1. The movable toilet, and movable track, inside of the uniquely designed alternating pressure mattress with circular opening gives the patient and hospital staff a sense of comfort because, should the patient unable to move but needing to eliminate human waste and no one is around, the patient is protected from the humiliating embarrassment that comes from not being able to go to the bathroom on their own and having to lay in their own feces or urine for any length of time or having to lay on a very painful bed-pan because of staff shortages. But with the movable toilet human waste is deposited into the movable toilet and it never touches the hospital staff or patient.

FIG. 3. Displays the uniquely designed fitted sheet with circular openings to accommodate the uniquely designed alternating pressure mattress with a circular opening.

FIG. 2. Displays the moveable-toilet-track extended which allows the toilet to extend for the removal of feces or urine without disturbing the patient thereby protecting hospital staff from unintentional contact with human waste materials.

1. This invention, a hospital bed with a movable toilet makes consumer lives easier and no other product on the market offers the same features.

2. This invention gives hospitals, nursing homes, assistant living facilities, doctors and nurses something easy to use that helps makes their lives easier and more comfortable in a temporary or permanent situation.

3. This invention protects patients from the humiliating embarrassment that comes with not being able to go to the bathroom on their own and having to lay in their own feces or urine for any length of time or having to lay on a very painful bed-pan because of staff shortages.

4. This invention according to claim 1, helps to save cost on undergarments bed dressings and diapers.

5. This invention according to claim 2, helps to protect doctors, nurses and hospital staff from germs and unwanted diseases.
